(19) United States
(12) Patent Application Publication
(10) Pub. No.: US 2009/0094092 A1
(43) Pub. Date: Apr. 9, 2009

(54) SYSTEM AND METHOD FOR ADVERTISEMENT PLACEMENT

(76) Inventor: Charles M. Hengel, Woodland, MN (US)

Correspondence Address: SCHWEGMAN, LUNDBERG & WOESSNER, P.A., P.O. BOX 2938, MINNEAPOLIS, MN, 55402, US

(21) Appl. No.: 11/866,764

(22) Filed: Oct. 3, 2007

(51) Int. Cl. G06Q 30/00; G06F 17/40; G06F 19/00

(52) U.S. Cl. 705/10; 705/37

(57) ABSTRACT

A system and method of advertisement is shown. By associating a theme of an advertisement with an aspect of a music performance, the advertisement can be played in a time slot that is adjacent to the music performance during a broadcast. The close temporal proximity of the advertisement to the music performance enhances the effectiveness of the advertisement. Methods and systems of making an association between an advertisement theme and a music performance are shown. Examples of associating methods and systems to implement them include auction methods and systems. One example includes online auctions and systems for implementing them.

### TECHNICAL FIELD

The present application relates to advertising and audio programming and in particular, to a system and method for advertisement placement.

### BACKGROUND

One common audio advertisement format is over audio airwaves such as FM, AM, satellite, etc. Other formats for audio advertisement include streaming audio over the internet. An advertiser purchases an amount of time which is subsequently scheduled to air during breaks between audio content, for example, music sets. Several factors can influence the amount of advertising impact that a given advertisement achieves. For example, the time of day selected for airing the advertisement, the demographics of the station listeners, and other factors can have an affect on the advertising impact.

### SUMMARY

Example 1 describes a machine-readable medium with instructions stored thereon, the instructions when executed operable to access an advertising request to associate an advertisement with a time slot adjacent to a music performance in an audio broadcast; and associate the music performance with the advertisement in the time slot.

In Example 2, the machine-readable medium of Example 1 is optionally configured to include instructions to associate an advertising theme with an aspect of the music performance.

In Example 3, the machine-readable medium of any one or more of Examples 1 or 2 are optionally configured to include instructions to analyze a metric of the music performance to determine the aspect of the music performance.

In Example 4, the machine-readable medium of any one or more of Examples 1-3 are optionally configured to include instructions to analyze radio airplay statistics to forecast an amount of future airplay for the music performance.

Example 5 describes a method comprising receiving an advertising request to associate an advertisement with a time slot adjacent to a music performance in an audio broadcast; and associating the music performance with the advertisement using the time slot.

In Example 6, the method of Example 5 is optionally performed such that associating the music performance with the advertisement includes selecting a theme of the advertisement; analyzing a metric of the music performance; and associating the advertisement with a music performance that has a metric that corresponds with the theme.

In Example 7, the method of any one or more of Examples 5 or 6 are optionally performed such that the theme is associated with a lyric in the music performance, and wherein the music performance comprises a song.

In Example 8, the methods of any one or more of Examples 5-7 are optionally performed such that the theme is associated with a genre of the music performance, and wherein the music performance comprises a song.

In Example 9, the methods of any one or more of Examples 5-8 are optionally performed such that the advertisement comprises a short-spot advertisement.

In Example 10, the methods of any one or more of Examples 5-9 are optionally performed such that the advertisement is a live-read advertisement.

Example 11 describes a method comprising determining a theme of an advertisement; determining an aspect of a music performance that corresponds with the theme of the advertisement; and associating the advertisement with a commercially available time slot adjacent to the music performance in an audio broadcast.

In Example 12, the method of Example 11 is optionally performed such that the theme of the advertisement is determined first, and the aspect of the music performance is selected to correspond with the theme.

In Example 13, the method of any one or more of Examples 11 or 12 are optionally performed such that the aspect of the music performance is determined first, and the theme of the advertisement is selected to correspond with the aspect.

In Example 14, the methods of any one or more of Examples 11-13 are optionally performed such that determining the aspect of the music performance includes determining a keyword lyric contained in the music performance.

In Example 15, the methods of any one or more of Examples 11-14 are optionally performed such that determining the aspect of the music performance includes determining a genre of the music performance.

In Example 16, the methods of any one or more of Examples 11-15 are optionally performed such that determining the aspect of the music performance includes determining an artist of the music performance.

In Example 17, the methods of any one or more of Examples 11-16 are optionally performed such that determining the aspect of the music performance includes determining a title of the music performance.

Example 18 describes a method comprising using radio airplay statistics to forecast an amount of future airplay for a music category; analyzing a characteristic of a song in the music category; providing the characteristic to an advertiser; and requesting a time slot to place the advertisement adjacent to the song in an audio broadcast.

In Example 19, the method of Example 18 is optionally performed such that analyzing the characteristic of the song in the music category includes analyzing a lyric of the song.

In Example 20, the method of any one or more of Examples 18 or 19 are optionally performed such that analyzing the characteristic of the song in the music category includes analyzing a rhythm of the song.

In Example 21, the methods of any one or more of Examples 18-20 are optionally performed such that analyzing the characteristic of the song in the music category includes analyzing a song ending style of the song.

In Example 22, the methods of any one or more of Examples 18-21 are optionally performed such that the music category includes work by an artist.

In Example 23, the methods of any one or more of Examples 18-22 are optionally performed such that the music category is characterized using a genre of music.

In Example 24, the methods of any one or more of Examples 18-23 are optionally performed comprising creating an advertisement with a theme that corresponds to the aspects of the song.

Example 25 describes a method comprising submitting an auction to associate an advertisement with a time slot adjacent to a music performance in an audio broadcast; receiving an offer to associate the advertisement with the time slot; and accepting the offer when the offer satisfies a price criterion.

In Example 26 the method of Example 25 is optionally performed such that the offer satisfies the price criterion when the offer includes an amount for immediate purchase.

In Example 27, the method of any one or more of Examples 25 or 26 are optionally performed such that the offer satisfies the price criterion when the offer is the best offer available at an end time of the auction.

In Example 28, the methods of any one or more of Examples 25-27 are optionally performed such that accepting the offer when the offer satisfies the price criterion includes accepting an advertiser's highest offer at an end time of the auction.

In Example 29, the methods of any one or more of Examples 25-28 are optionally performed such that accepting the offer when the offer satisfies the price criterion includes accepting a broadcaster's lowest offer at an end time of the auction.

In Example 30, the methods of any one or more of Examples 25-29 are optionally performed such that the auction further comprises a maximum cost per thousand (CPM) presentations.

In Example 31, the methods of any one or more of Examples 25-30 are optionally performed comprising rejecting the offer when the offer exceeds the maximum CPM.

In Example 32, the methods of any one or more of Examples 25-31 are optionally performed such that the auction further comprises a market, a budget, and a duration.

Example 33 describes a method comprising using radio airplay statistics to forecast an amount of future airplay for a music category; analyzing a metric of a song in the music category; submitting an auction to associate an advertisement with a time slot adjacent to a song in the music category; receiving an offer to associate the advertisement with the time slot; accepting the offer when the offer satisfies a price criterion.

In Example 34 the method of Example 33 is optionally performed such that analyzing the metric of the song in the music category includes analyzing lyrics of songs in the music category.

In Example 35, the method of any one or more of Examples 33 or 34 are optionally performed such that analyzing the metric of the song in the music category includes analyzing a rhythm of a song in the music category.

In Example 36, the methods of any one or more of Examples 33-35 are optionally performed such that analyzing the metric of the song in the music category includes analyzing a song ending style of the song in the music category.

In Example 37, the methods of any one or more of Examples 33-36 are optionally performed such that the music category includes a song by a particular artist.

In Example 38, the methods of any one or more of Examples 33-37 are optionally performed such that the music category includes a genre of music.

In Example 39, the methods of any one or more of Examples 33-38 are optionally performed such that accepting the offer when the offer satisfies the price criterion includes accepting an advertiser's highest offer at an end time of the auction.

In Example 40, the methods of any one or more of Examples 33-39 are optionally performed such that accepting the offer when the offer satisfies the price criterion includes accepting a broadcaster's lowest offer at an end time of the auction.

In Example 41, the methods of any one or more of Examples 33-40 are optionally performed such that accepting the offer when the offer satisfies the price criterion includes an advertiser accepting an offer that decays over time as the end time of the auction approaches.

In Example 42, the methods of any one or more of Examples 33-41 are optionally performed such that accepting the offer when the offer satisfies the price criterion includes an advertiser accepting an offer that increases over time as the end time of the auction approaches.

Example 43 describes a machine-readable medium with instructions stored thereon, the instructions when executed by a machine, cause the machine to submit of an auction to associate an advertisement with a time slot adjacent to a music performance in an audio broadcast; receive of an offer to associate the advertisement with the time slot; and accept of the offer when the offer satisfies a price criterion.

In Example 44, the machine-readable medium of Example 43 optionally includes instructions to receive an offer to associate an advertising theme with an aspect of the music performance.

In Example 45, the machine-readable mediums of any one or more of Examples 43 or 44 are optionally configured such that the aspect includes at least one music performance keyword that matches an advertisement keyword.

Example 46 describes a system comprising a first module configured to receive a request to associate an advertisement with a time slot adjacent to a music performance during an audio broadcast; and a second module configured to associate the advertisement with the music performance.

In Example 47, the system of Example 46 is optionally configured comprising a third module configured to choose a time slot from a plurality of time slots and schedule the advertisement using the chosen time slot.

In Example 48, the systems of any one or more of Examples 46 or 47 are optionally configured such that the third module is further configured to assign a price to the time slot as a function of a temporal relationship between the advertisement and the music performance.

In Example 49, the systems of any one or more of Examples 46-48 are optionally configured such that the third module is further configured to assign a premium price to the time slot when the time slot is directly adjacent to the music performance.

In Example 50, the systems of any one or more of Examples 46-49 are optionally configured such that the third module is further configured to assign a premium price to the time slot when the time slot is positioned after the music performance.

In Example 51, the systems of any one or more of Examples 46-50 are optionally configured comprising a fourth module configured to check for an already existing association with the music performance and provide existing association information to a user.

Example 52 describes a system comprising a broadcaster computer; a processing system to run on the broadcaster computer, wherein the processing system is configured to schedule an advertisement to play in a time slot during an audio broadcast adjacent to a music performance, wherein the advertisement is provided by an advertiser and wherein the music performance is chosen by the advertiser; and play the advertisement during the time slot, whereby the advertisement is reinforced by having the corresponding music performance presented close in time.

In Example 53, the system of Example 52 is optionally configured such that the processing system is configured to play an advertisement with a theme during the time slot, wherein the theme corresponds to the music performance.

In Example 54, the systems of any one or more of Examples 52 or 53 are optionally configured such that the theme comprises a theme keyword that corresponds with a music performance keyword associated with the music performance.

In Example 55, the systems of any one or more of Examples 52-54 are optionally configured such that the theme corresponds to a genre of the music performance.

In Example 56, the systems of any one or more of Examples 52-55 are optionally configured such that the theme corresponds to an artist associated with the music performance.

Example 57 describes a system comprising a client computer; a server computer, communicatively connected to the client computer with a network system; and a processing system to run on the client computer, wherein the processing system is configured to: receive input describing an auction to be placed, wherein the auction is provided to the server computer using the network system, and wherein the auction comprises a sale of an advertising time slot adjacent to a music performance during an audio broadcast.

In Example 58, the system of Example 57 is optionally configured such that the server computer includes a server computer processing system configured to search a programming schedule database to determine an available advertising time slot adjacent to a scheduled broadcast of the music performance.

In Example 59, the systems of any one or more of Examples 57 or 58 are optionally configured such that the auction is designed to associate an advertisement with a number of time slots adjacent to broadcast air times of the music performance over a period of time.

In Example 60, the systems of any one or more of Examples 57-59 are optionally configured such that the auction is designed to associate an advertising campaign with a number of time slots adjacent to a number of related music performances.

In Example 61, the systems of any one or more of Examples 57-60 are optionally configured such that the auction is designed to associate a theme of an advertisement with a time slot adjacent to a music performance that corresponds to the theme.

In Example 62, the systems of any one or more of Examples 57-61 are optionally configured such that a server computer processing system is further configured to search a music performance database to match a theme keyword with a music performance keyword.

In Example 63, the systems of any one or more of Examples 57-62 are optionally configured such that the server computer is configured to provide the client computer with airplay forecast statistics for the music performance.

This overview is intended to provide an overview of the subject matter of the present patent application. It is not intended to provide an exclusive or exhaustive explanation of any one or more inventions that may be described herein. The detailed description is included to provide further information about the subject matter of the present patent application.

### BRIEF DESCRIPTION OF THE DRAWINGS

Some embodiments are illustrated by way of example and not limitation in the figures of the accompanying drawings in which:

FIG. 1 is a diagram of an example system, according to an example embodiment;

FIG. 2 illustrates a portion of an audio broadcast, according to an example embodiment;

FIG. 3 is a flow diagram illustrating a method of associating an advertisement with a music performance, according to an example embodiment;

FIG. 4 is a flow diagram illustrating a method of associating music performances with advertisements using a common theme, according to an example embodiment;

FIG. 5 is a flowchart illustrating a method of using airplay data to associate an advertisement with a music performance, according to an example embodiment;

FIG. 6 is a flow diagram illustrating a method of associating music performances with advertisements, according to an example embodiment;

FIG. 7 is a flow diagram illustrating a method of using an auction model for associating music performances with advertisements, according to an example embodiment;

FIG. 8 is a flow diagram illustrating a method of using an auction model for associating music performances with advertisements, according to an example embodiment;

FIG. 9 is a block diagram of an advertisement placement system that can be used to implement methods described above and other methods to associate advertisements with music performances, according to an example embodiment;

FIG. 10 is a block diagram illustrating operating modules of the placement computer, according to an example embodiment; and

FIG. 11 illustrates a diagrammatic representation of a machine capable of performing the methods or implementing the systems/devices described herein according to an example embodiment.

### DETAILED DESCRIPTION

In the following description, for purposes of explanation, numerous specific details are set forth in order to provide a thorough understanding of example embodiments. It may be evident, however, to one skilled in the art that the present disclosure may be practiced without these specific details.

In the following description, the term “adjacent” is used to describe things in close proximity to other things. The term “directly adjacent” is used when there are no intervening objects in between. In the following description, the term “best offer” in an auction context may refer to the best offer at a point in time during the duration of the auction, such as at the end of the auction. Depending on the type of auction being conducted, the best offer may be the highest amount offered, such as in a conventional auction, or the lowest amount offered, such as in a reverse auction. Other types of auctions are considered to be within the scope of this disclosure, with each auction type having a method of bidding that describes a best offer. If two or more offers are the same in one criteria, such as the same dollar amount, a “best offer” may consider additional criteria, such as which offer was the first in time. In the following description, a “music performance” includes a song, jingle, melody, instrumental, orchestral arrangement, or choral arrangement that is played in a broadcast. In the following description, a “metric” of a music performance includes, but is not limited to: a keyword or keywords in lyrics, a genre (pop, jazz, rock and roll, etc.), a number of beats per minute, a style or type of introduction or ending, a title, an artist, a composer, a chart rating, or an amount of airtime in a given period.

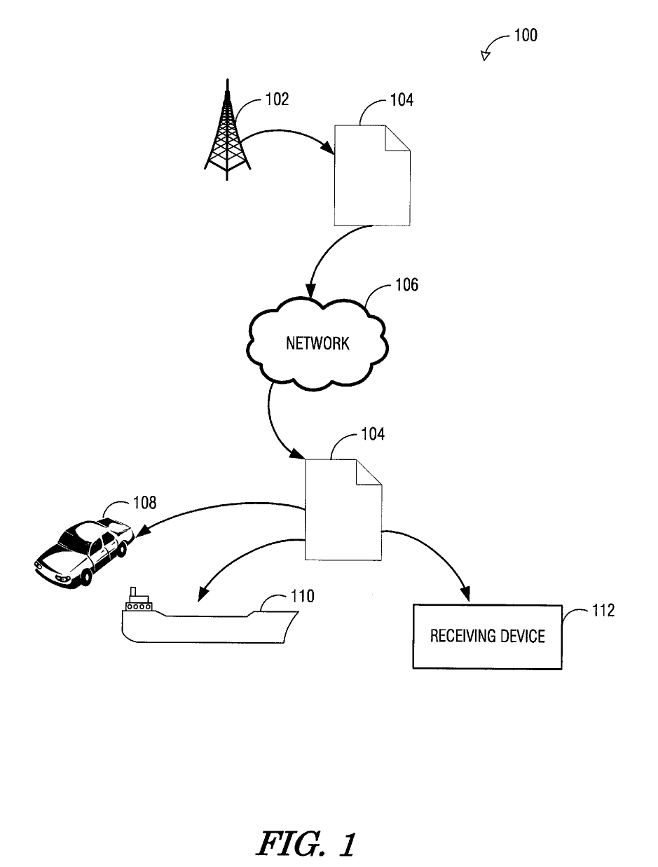

FIG. 1 is a diagram of an example system 100, according to an example embodiment. Illustrated is a broadcasting station 102 that broadcasts an advertisement 104 over a network 106. The network 106 may be, for example, a variety of stations connected by some regulated broadcasting frequency such as a radio, television or satellite. In some embodiments, the network maybe an internet or other type of suitable network. The advertisement 104 is broadcast to a variety of different types of devices that may reside in a variety of different types of locations, vehicles, etc. For example, the advertisement 104 may be broadcast across the network 106 to a car or automobile 108. In other cases, the advertisement 104 is broadcast across the network 106 to a ship 110. In still other cases, this advertisement 104 is broadcast across the network 106 to a device 112. The device may include a cell phone, a computer system, a radio, a television, a Personnel Digital Assistant (PDA), or other suitable receiving device. In some cases, one or more of these devices 112 is utilized by a user to review, hear, or otherwise receive, the advertisement 104.

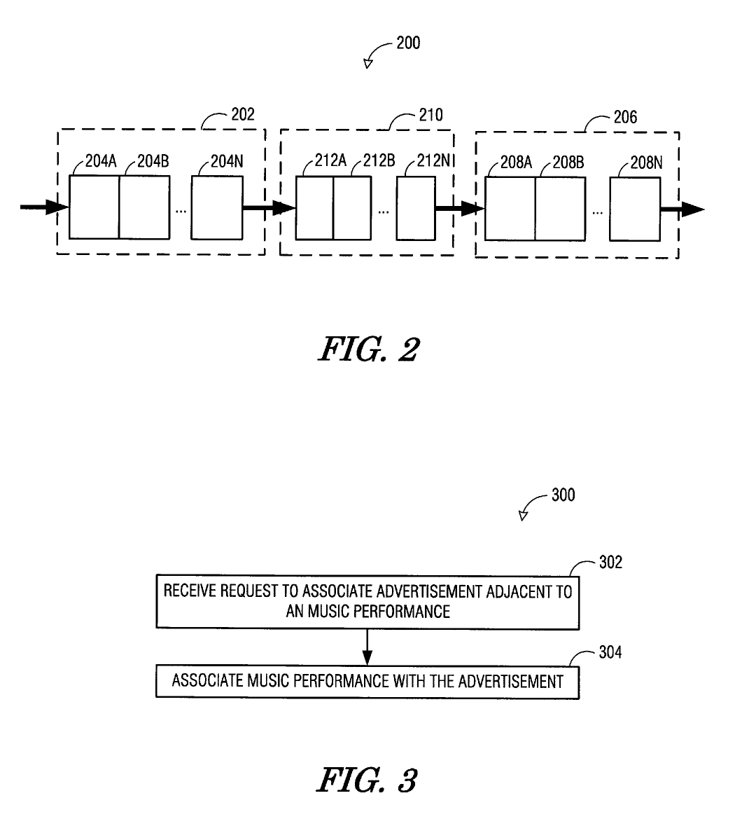

FIG. 2 illustrates a portion of an audio broadcast 200, according to an example embodiment. The audio broadcast 200 includes a first audio content block 202 having one or more music performances 204A, 204B, . . . , 204N (collectively 204) that make up the content block 202. A second audio content block 206 is likewise shown, including one or more music performances 208A, 208B, . . . , 208N (collectively 208). Examples of music performances such as 204 and 208 include traditional music tracks or songs, talk show tracks, a caller segment track, a news report, a weather report, a contest, etc.

An advertisement block 210 is shown between the first audio content block 202 and the second audio content block 206. The advertisement block 210 includes one or more time slots 212A, 212B, . . . , 212N (collectively 212). After selling time slots 212 and programming the broadcast 200, the individual time slots 212 will be filled with individual advertisements. Time slots 212 may vary in length from 5 seconds to a minute or more. For the purposes of illustration, two audio content blocks and one advertisement block 210 are shown. One of ordinary skill in the art having the benefit of the present disclosure will recognize that more audio content blocks and more advertisement blocks may exist in a given daily broadcast schedule.

A number of different types of advertisements are used to fill the time slots 212. In an example, a short-spot advertisement is used to fill one or more time slots 212. For example, a short-spot advertisement may include an advertisement with a relatively short run time, such as five seconds or fifteen seconds. Other advertisements may have run lengths such as 30 second spots, 60 second spots, etc. In an example, an advertisement is pre-recorded. In an example, the advertisements are read live by an announcer. Examples of an announcer include disc jockeys or other media broadcast personnel. For example, an announcer may use a teleprompter or a computer screen configured to display an advertising script at some period of time before the advertisement block 210 in the broadcast schedule 200. In an example, the advertisement is text that is read verbatim. In another example, the advertisement is a theme or idea that is ad-libbed in whole or in part by the announcer.

A method for increasing an effectiveness of an advertisement includes placing a particular advertisement in a time slot 212 adjacent to a music performance 204, 208. In an embodiment, an advertisement is placed directly adjacent to a music performance 204, 208. In another embodiment, an advertisement is placed adjacent to a music performance 204, 208.

FIG. 2 further shows a first music performance 204N in the first audio content block 202 that is directly adjacent in time with a first time slot 212A. Because of its proximity, the first time slot 212N may represent the most desirable time slot to associate with the corresponding music performance 204N. FIG. 2 further shows a second time slot 212B that is adjacent to the first music performance 204N, but not directly adjacent to the first music performance 204N. In an embodiment, the second time slot 212B is still proximate enough to the first music performance 204N to increase an effectiveness of an advertisement placed in the second time slot 212B. The example shown in FIG. 2 illustrates the music performance occurring earlier in time than the advertisement. In other embodiments, the advertisement occurs before the music performance and is placed adjacent or directly adjacent to the music performance.

In an embodiment, a pricing model is included that charges a different rate for advertisements placed directly adjacent to a selected music performance in contrast to one or more degrees of separation from the audio track, such as the second time slot 212B, etc.

FIG. 3 is a flow diagram illustrating a method 300 of associating an advertisement with a music performance, according to an example embodiment. At 302, a request to associate an advertisement with a time slot in an audio broadcast adjacent to a music performance is received. At 304, the music performance is associated with the advertisement using the time slot.

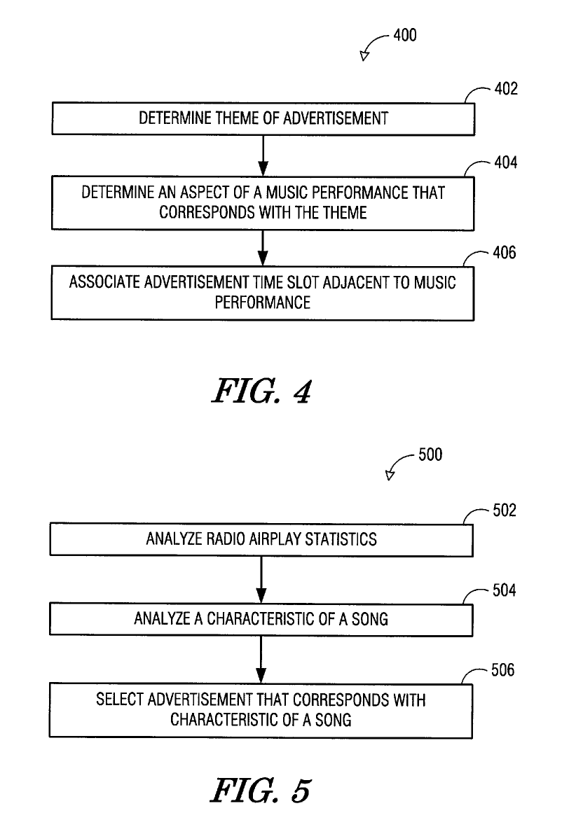

Various methods may be used to select a music performance to associate an advertisement with. FIG. 4 is a flow diagram illustrating a method 400 of associating music performances with advertisements using a common theme, according to an example embodiment. In an embodiment, a common theme between an advertisement and a musical performance is used to determine a time slot. At 402, a theme of the advertisement is determined. For example, an appropriate theme for an advertisement promoting a summer contest includes a keyword “summer.” In an embodiment, a theme for an advertisement includes a single word. In other embodiments, a theme for an advertisement include a plurality of keywords, a phrase, etc.

At 404, an aspect of a music performance that corresponds with the theme of the advertisement is determined. For example, if an advertisement theme includes a single word “summer,” a possible corresponding aspect of a music performance includes a song with the word summer in the title, or in the lyrics, etc. Other aspects that may be used include, but are not limited to, a genre of a music performance, an artist associated with a music performance, and a title of a music performance. Although selecting a theme for an advertisement and subsequently matching a music performance is described, the disclosure is not so limited. In an embodiment, a music performance is determined or selected and an advertisement is subsequently chosen to match the music performance.

At 406, the advertisement is associated with a time slot in an audio broadcast adjacent to the music performance. The advertisement may be positioned in a time slot directly adjacent to the music performance. The advertisement may also be placed in a time slot adjacent, but not directly adjacent, to the music performance.

In an example, a music performance, or music category is chosen after analysis of airplay statistics. FIG. 5 is a flowchart illustrating a method 500 of using airplay data to associate an advertisement with a music performance, according to an example embodiment. At 502, one or more radio airplay statistics are analyzed to forecast an amount of future airplay for a music category. In various examples, the forecast may be projected out a week, a month, a quarter, or some other period of time. In various embodiments, the music category may include one or more songs by a particular artist or a genre of music. Other music categories are understood to be included in the scope of this disclosure, such as categories based on release dates, producer, or record label. In an embodiment, the airplay statistics may be used to analyze a particular song or set of songs, which may be a subset of a music category.

At 504, one or more characteristics of a song in the music category are analyzed. In various embodiments, the characteristics may include, but are not limited to, a lyric, a rhythm, an ending style, an opening style, a genre, an artist, a producer, a performer, an album, a year or period of production or release, or the like. In an embodiment, more than one song is analyzed in the music category.

At 506, an advertisement with a theme that corresponds with a characteristic of the song is selected. In an embodiment, an advertisement can be designed, such as by an advertising agency, to incorporate or use the characteristic of the song as a theme for the advertisement. Such design may be more effective when played adjacent to selected music performance or performances. The airplay forecast data provides an estimated amount of exposure when placed adjacent to selected music performances.

A number of methods of pairing an advertisement theme with a music performance are included in the present disclosure. In an embodiment, a genre of music is associated with an advertisement theme. For example, a genre of “surfing music” may be associated with an advertisement using a summer theme. In another embodiment, an artist is associated with an advertisement theme. For example, a song by performed by “The Cars” may be associated with an advertisement for an automobile show. Although a number of example themes and music performance characteristics are discussed, the disclosure is not so limited. Other advertising themes and music performance characteristics will be recognized by one of ordinary skill in the art as being within the scope of the disclosure.

In an embodiment, apart from themes, an advertisement is associated consistently with a music performance to form a connection that is perceived by a listener. For example, only upbeat or otherwise happy songs or other music performances can be selected to be adjacent to a given advertisement, while avoiding dark or moody songs or music performances. In another example, a particular artist or a particular song is associated with advertisements. In such examples there need not be a theme that corresponds to the music performance or tracks, however a consistent criteria of music performances is maintained.

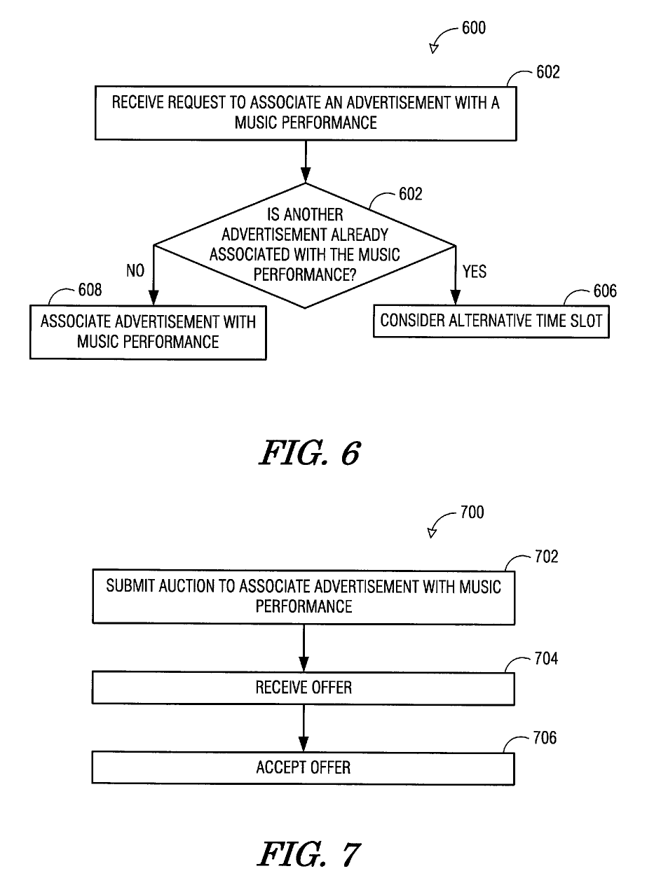

FIG. 6 is a flow diagram illustrating a method 600 of associating music performances with advertisements, according to an example embodiment. In an embodiment, the method of FIG. 6 is facilitated using computer software. At 602, a request is received to associate an advertisement with a time slot adjacent to a music performance in an audio broadcast. At 604, it is determined whether another advertisement is already associated with the music performance in question. In an embodiment, if an association already exists for another advertising customer, at 606, a second time slot that is also adjacent to the music performance can be considered. In an embodiment, if an association already exists for another advertising customer the music performance can be considered occupied, and a different music performance can be sought. At 608, if the association does not already exist, an association is created between the advertisement and the music performance by slotting the advertisement into the time slot.

As stated above, although the disclosure is not so limited, in an embodiment computer software is used to perform associations, checking, and other operations of the methods described in FIGS. 3-6. In an embodiment, computer software searches for information of advertisers looking to make a particular association. In an embodiment such software gathers additional information regarding advertiser's preferences, including but not limited to demographic target group, geographical area, time of day preference, etc. In an embodiment the computer search includes searching a local database. In an embodiment the computer search includes searching an external database. In an embodiment, the computer search includes searching metadata or the like over the internet. In an embodiment, in addition to searching for advertiser's preference, the computer program searches for music performance data such as lyrics, title, artists, themes, etc. One example of a database containing metrics for music performances includes a music genome database such as Pandora T. The software can then compare and rank recommendations of music performances to a potential advertiser.

FIG. 7 is a flow diagram illustrating a method 700 of using an auction model for associating music performances with advertisements, according to an example embodiment. At 702, an auction is submitted to associate an advertisement with a time slot adjacent to a music performance in an audio broadcast. The auction may be submitted by an advertiser seeking to sell an advertisement adjacent to a music performance, in an embodiment. In another embodiment, the auction may be submitted by a broadcaster to sell an advertising time slot adjacent to a music performance.

At 704, one or more offers are received to associate the advertisement with the time slot adjacent to the music performance. Depending on which party (e.g., advertiser or broadcaster) submits an auction, the corresponding offer may be different. For example, in the case of a broadcaster that submits an auction to sell an advertising time slot to one or more advertisers, the offer may include a dollar amount and the best offer may be considered the highest offer at a particular time. As another example, in the case of an advertiser auctioning to sell an advertisement in close proximity to a music performance, one or more broadcasters may offer the advertiser lower costs (e.g., CPM, or price per exposure or presentation) in an effort to win the advertiser's business.

At 706, an offer is accepted when the offer satisfies a price criterion. In an embodiment, the offer satisfies the price criterion when the offer includes an amount for immediate purchase. For example, the auction may include a reserve price, which when met, may automatically or immediately end the auction in favor of the bidder. In an embodiment, the offer satisfies the price criterion when the offer is the best offer at an end time of the auction.

As discussed above, the best offer may be constructed within the context of the auction. In an example, a best offer includes a highest bid from an advertiser. In an example, a best offer includes a bid of a lowest cost from a broadcaster. In an embodiment, the auction may include a maximum cost per thousand (CPM) presentations. An advertiser may include a restriction of CPM to maintain some control over the scope and cost of the potential advertising campaign, whereas a broadcaster may include a restriction of CPM to manage how much exposure any one particular advertiser may have during an audio broadcast. Should a broadcaster submit an offer that includes a CPM that exceeds the advertiser's maximum CPM, then the offer may be rejected. Similarly, should an advertiser submit an offer that includes a CPM that exceeds the broadcaster's maximum CPM, then the offer may be rejected.

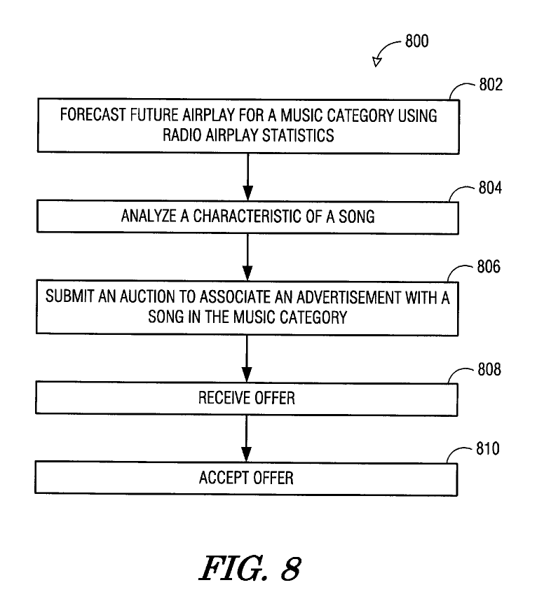

FIG. 8 is a flow diagram illustrating a method 800 of using an auction model for associating music performances with advertisements, according to an example embodiment. At 802, one or more radio airplay statistics are used to forecast an amount of future airplay for a music category. At 804, one or more characteristics of a song in the music category are analyzed. The analysis may be implemented as described above. At 806, an auction is submitted to associate an advertisement with a time slot adjacent to a song in the music category. At 808, one or more offers are received to associate the advertisement with the timeslot. At 810, an offer is accepted when the offer satisfies a price criterion. In an embodiment, an auction includes a time element for bids or offers received. In an embodiment, an offer may decay over time. For example, in a conventional auction (e.g., where a broadcaster sells advertisement time slots to one or more advertisers), an offer to buy the time slot may start at a particular dollar amount and decay over time as the end of the auction approaches. This type of operation may encourage earlier acceptance of the offer and increase the fluidity of the market. In another example, in a reverse auction, such as when an advertiser auctions an advertisement to be placed adjacent to a music performance, one or more broadcasters may bid with competitively lower costs. The costs (e.g., bids) may increase over time as the auction proceeds. Again, this may encourage the advertiser to accept the offer earlier in the life of the auction. Other aspects of the operation of an auction may be implemented as described above or by other methods that will be recognized by one of ordinary skill in the art.

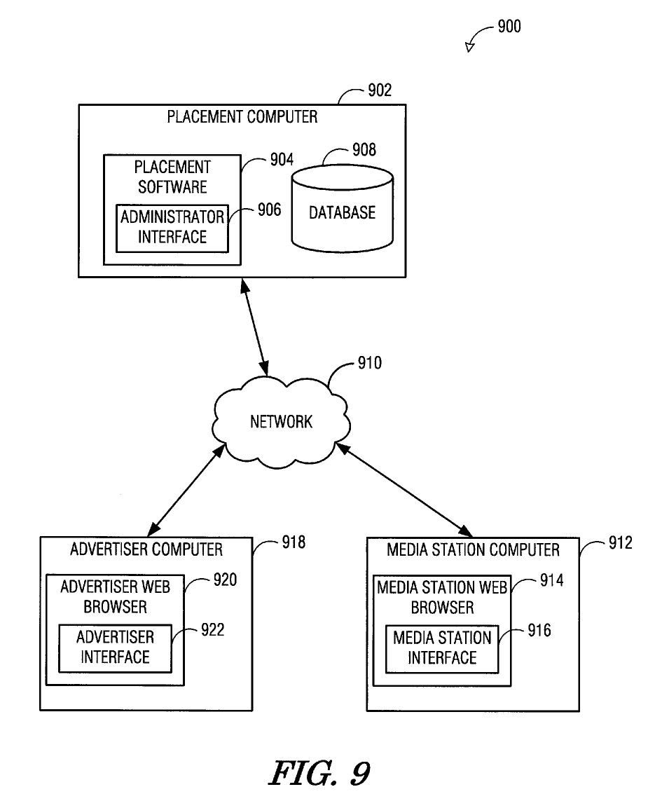

FIG. 9 is a block diagram of an advertisement placement system 900 that can be used to implement methods described above and other methods to associate advertisements with music performances, according to an example embodiment. In an embodiment, the advertising placement system 900 includes a placement computer 902. The placement computer 902 may include, in embodiments, placement software 904, an administrator interface 906, and a database 908.

In some embodiments, the placement software 904 includes markup language documents (e.g., HTML), script files (e.g., JavaScript, Active Server Pages, CGI, Perl), library files (e.g., DLL), or executable files (e.g., EXE). In a further embodiment, the placement software 904 includes database and network interfaces, such as to connect to database 908 or network 910. The placement software 904 may, in some embodiments, be implemented within a web server environment. In alternative embodiments, the placement software 904 includes a proprietary server application and uses proprietary client applications to enable the placement system 900.

The placement computer administrator interface 906 may be provided by placement software 904 using one or more of the technologies described above. In particular, in an embodiment, the administrator interface 906 is provided to a user (e.g., administrator) in a web browser (e.g., Microsoft Internet Explorer). The administrator interface 906 may include a combination of static and dynamic elements as described in more detail below. An administrator may use the administrator interface 906 to determine or manage availability, security, and access of placement computer 902.

The database 908 may be implemented as a relational database, a central database, a distributed database, an object database, or a flat file database, in various embodiments. The database 908 may include various data, such as airplay forecast data of one or more music performances, music performance characteristic data (e.g., title, track, album, artist, performer, producer, play length, release date, etc.), music performance keyword data (e.g., metadata), which may describe or characterize music performance themes, broadcast data (e.g., future or past broadcast schedules, advertising time slot data, etc.), auction data (e.g., user accounts, auction information, bid information, payment information, fulfillment information, etc.), or other data used by the advertisement placement system 900.

In addition, the advertisement placement system 900 may include one or more media station computers 912 (e.g., clients). In an embodiment, each media station computer 912 includes a media station web browser 914, which may connect to the placement computer 902 via the network 910. The media station web browser 914 can be used to provide a media station interface 916. The media station interface 916 may be used by users (e.g., a media station advertising administrator) to provide details about a media station, such as demographic profile and advertising costs.

The network 910 may include, in various embodiments, wired or wireless network connections. In addition, the network 910 may be implemented as a local area network (LAN), wide area network (WAN), or a combination. In an example embodiment, the network 910 includes the Internet.

In addition, the advertisement placement system 900 may include one or more advertiser computers 918. Similar to users of the media station computer 914, users of an advertiser computer 920 may use a web browser (e.g., advertiser web browser 920) to access the placement computer 902 via the network 910. The advertiser interface 922 may be provided by placement software 904 and presented using advertiser web browser 920.

In operation in an example embodiment, a media station user can use media station computer 912 and connect to the placement computer 902 via the network 910. If the media station user had not previously connected with placement computer 902, then in an embodiment, the media station user may have to create an account. Using media station interface 916, the media station user can provide media station characteristics (e.g., demographics or geography of the listening audience) and, in an example embodiment, a minimum amount the media station will accept to air an advertisement.

An advertising user may connect to the placement computer 902 using the advertiser computer 918 via network 910. In an embodiment, if the advertising user has not used the system 900 before to place advertising, then the advertising user may have to create an account on placement computer 902. The advertising user may use the advertiser computer 918 to submit a request to associate an advertisement with a time slot adjacent to a music performance, to submit an auction for such a placement, or to manage such requests or auctions, in various embodiments.

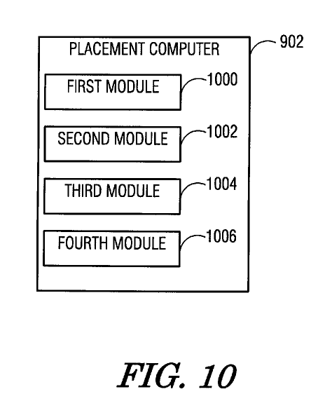

FIG. 10 is a block diagram illustrating operating modules of the placement computer 902, according to an example embodiment. As shown in FIG. 10, the placement computer 902 may include a first module 1000, a second module 1002, a third module 1004, and a fourth module 1006. In an embodiment, the first module 1000 is configured to receive a request to associate an advertisement with a time slot adjacent to a music performance during an audio broadcast. The request may be received from a client, such as the advertiser computer 918. The request may include an auction or an offer (e.g., bid) related to an existing auction. The second module 1002 is configured to associate the advertisement with the music performance. The second module 1002 may be operable after the conclusion of an auction, for example. The third module 1004 and the fourth module 1006 may be optionally available in the placement computer 902, in various embodiments. The third and fourth modules 1004, 1006 may be optionally configured to perform one or more operations. In an embodiment, the third or fourth modules 1004, 1006 are configured to not perform any operations.

In an embodiment, the third module 1004 is configured to choose a time slot from a plurality of time slots and schedule the advertisement using the chosen time slot.

In an embodiment, the third module 1004 is further configured to assign a price to the time slot as a function of a temporal relationship between the advertisement and music performance. For example, time slots that are directly adjacent to a music performance may be considered premium time slots and accordingly demand a higher price in comparison to time slots farther away from the music performance.

In an embodiment, the third module is further configured to assign a premium price to the time slot when the time slot is positioned after the music performance. In some cases, it may be preferable to obtain the time slot following a music performance, perhaps, for example, to play off of a particular ending of the music performance.

In an embodiment, the fourth module 1006 is configured to check for an already existing association with the music performance and provide existing association information to a user. For example, if a request is made to associate an advertisement with a particular time slot and the time slot has already been assigned, the user making the request may be notified of the unavailability of the time slot and allowed to choose or request a different time slot.

In some embodiments, a broadcaster computer, such as, for example, media station computer 912 or placement computer 902, may include a processing system configured to schedule and play advertisements. In an embodiment, the processing system schedules and advertisement to play in a time slot in an audio broadcast adjacent to a music performance. The advertisement may be provided by an advertiser and the music performance may be chosen by the advertiser. The processing system may also be configured to play the advertisement during the time slot. Such positioning may have the affect of reinforcing the advertising by having the corresponding music performance presented close in time. In an embodiment, the processing system is configured to play an advertisement using a theme of the advertisement as it corresponds with a music performance. The theme may be based on a theme keyword with the correspondence being a relation between the theme keyword and a music performance keyword associated with the music performance. In another embodiment, the theme corresponds with an artist associated with the music performance.

In some embodiments, a processing system running on a client computer, such as, for example, an advertiser computer 918 or a media station computer 912, may be configured receive and process auctions. In an embodiment, the processing system is configured to receive input describing an auction to be placed, where the auction includes a sale of an advertising time slot adjacent to a music performance during an audio broadcast. A server computer, such as, for example, the placement computer 902, may be configured to search a programming schedule database for an available advertising time slot adjacent to a scheduled broadcast of the music performance. The server computer may be used to determine whether an auction is feasible or worthwhile. For example, an advertiser interested in purchasing a time slot directly adjacent to a particular music performance may reconsider after searching a programming schedule to find that the time slots are filled for the immediate future.

In an embodiment, the auction to be placed may be designed to associate an advertisement with one or more time slots adjacent to broadcasts of the music performance. In an embodiment, the auction may be designed to associate an advertising campaign with one or more time slots adjacent to one or more related music performances. For example, an advertising campaign may include one or more similar or related advertisements. An advertiser may want to design the advertising campaign to correspond with one or more music performances and arrange to have the advertisements in the advertising campaign to be broadcasted using time slot adjacent to the music performances. The advertiser may use the server computer to search for music performances that match a particular theme keyword or to view forecast data related to a music performance.

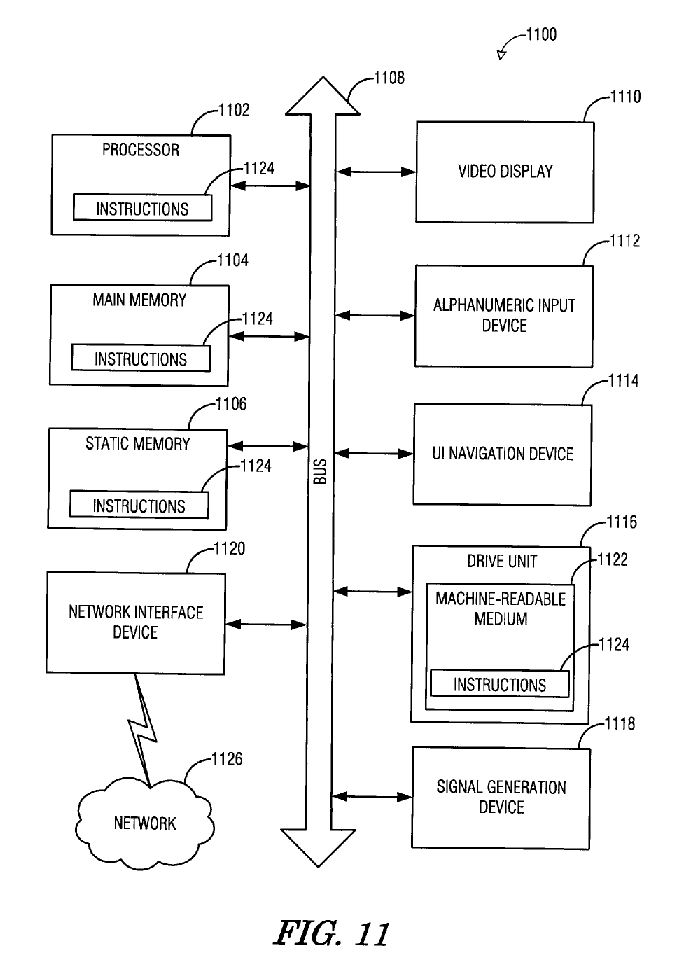

FIG. 11 illustrates a diagrammatic representation of a machine 1100 capable of performing the methods or implementing the systems/devices described herein according to an example embodiment. In alternative embodiments, the machine may comprise a computer, a network router, a network switch, a network bridge, a Personal Digital Assistant (PDA), a cellular telephone, a web appliance, a set-top box (STB) or any machine capable of executing a sequence of instructions that specify actions to be taken by that machine.

The machine 1100 includes a processor 1102, a main memory 1104, and a static memory 1106, which communicate with each other via a bus 1108. The machine 1100 may further include a video display unit 1110 (e.g., a liquid crystal display (LCD) or a cathode ray tube (CRT)). The machine 1100 also includes an alphanumeric input device 1112 (e.g., a keyboard), a user interface navigation device 1114 (e.g., a mouse), a disk drive unit 1116, a signal generation device 1118 (e.g., a speaker) and a network interface device 1120 to interface the computer system to a network 1126.

The disk drive unit 1116 includes a machine-readable medium 1122 on which is stored a set of instructions or software 1124 embodying any one, or all, of the methodologies described herein. The software 1124 is also shown to reside, completely or at least partially, within the main memory 1104 and/or within the processor 1102. The software 1124 may further be transmitted or received via the network interface device 1120 using the network 1126.

For the purposes of this specification, the term “machine-readable medium” shall be taken to include any medium which is capable of storing or encoding a sequence of instructions for execution by the machine and that cause the machine to perform any one of the methodologies of the inventive subject matter. The term “machine-readable medium” shall accordingly be taken to include, but not be limited to, solid-state memories, optical and magnetic disks, and carrier wave signals. Further, while the software is shown in FIG. 11 to reside within a single device, it will be appreciated that the software could be distributed across multiple machines or storage media, which may include the machine-readable medium.

It is to be understood that the above description is intended to be illustrative and not restrictive. Although numerous characteristics and advantages of various embodiments as illustrated herein have been set forth in the foregoing description, together with details of the structure and function of various embodiments, many other embodiments and changes to details may be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels and are not intended to impose numerical requirements on their objects.

The Abstract of the Disclosure is provided to comply with 37 C.F.R. § 1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
submitting an auction to associate an advertisement with a time slot adjacent to a music performance in an audio broadcast;
receiving an offer to associate the advertisement with the time slot; and
accepting the offer when the offer satisfies a price criterion.

2. The method of claim 1, wherein the offer satisfies the price criterion when the offer includes an amount for immediate purchase.

3. The method of claim 1, wherein the offer satisfies the price criterion when the offer is the best offer available at an end time of the auction.

4. The method of claim 1, wherein accepting the offer when the offer satisfies the price criterion includes accepting an advertiser's highest offer at an end time of the auction.

5. The method of claim 1, wherein accepting the offer when the offer satisfies the price criterion includes accepting a broadcaster's lowest offer at an end time of the auction.

6. The method of claim 5, wherein the auction further comprises a maximum cost per thousand (CPM) presentations.

7. The method of claim 6, further comprising:
rejecting the offer when the offer exceeds the maximum CPM.

8. The method of claim 1, wherein the auction further comprises a market, a budget, and a duration.

9. A method comprising:
using radio airplay statistics to forecast an amount of future airplay for a music category;
analyzing a metric of a song in the music category;
submitting an auction to associate an advertisement with a time slot adjacent to a song in the music category;
receiving an offer to associate the advertisement with the time slot;
accepting the offer when the offer satisfies a price criterion.

10. The method of claim 9, wherein analyzing the metric of the song in the music category includes analyzing lyrics of songs in the music category.

11. The method of claim 9, wherein analyzing the metric of the song in the music category includes analyzing a rhythm of a song in the music category.

12. The method of claim 9, wherein analyzing the metric of the song in the music category includes analyzing a song ending style of the song in the music category.

13. The method of claim 9, wherein the music category includes a song by a particular artist.

14. The method of claim 9, wherein the music category includes a genre of music.

15. The method of claim 9, wherein accepting the offer when the offer satisfies the price criterion includes accepting an advertiser's highest offer at an end time of the auction.

16. The method of claim 9, wherein accepting the offer when the offer satisfies the price criterion includes accepting a broadcaster's lowest offer at an end time of the auction.

17. The method of claim 9, wherein accepting the offer when the offer satisfies the price criterion includes an advertiser accepting an offer that decays over time as the end time of the auction approaches.

18. The method of claim 9, wherein accepting the offer when the offer satisfies the price criterion includes an advertiser accepting an offer that increases over time as the end time of the auction approaches.

19. A machine-readable medium with instructions stored thereon, the instructions when executed by a machine, cause the machine to:
submit of an auction to associate an advertisement with a time slot adjacent to a music performance in an audio broadcast;
receive of an offer to associate the advertisement with the time slot; and
accept of the offer when the offer satisfies a price criterion.

20. The machine-readable medium of claim 19, further including instructions to receive an offer to associate an advertising theme with an aspect of the music performance.

21. The machine-readable medium of claim 20, wherein the aspect includes at least one music performance keyword that matches an advertisement keyword.
